(19) United States
(12) Patent Application Publication
(10) Pub. No.: US 2026/0211602 A1
(43) Pub. Date: Jul. 23, 2026

(54) CONTROL DEVICE

(71) Applicant: FANUC CORPORATION, Yamanashi (JP)

(72) Inventors: Masaaki SHINDOU, Yamanashi (JP); Kouji SEKIMOTO, Yamanashi (JP)

(21) Appl. No.: 19/138,663

(22) PCT Filed: Jan. 6, 2023
(86) PCT No.: PCT/JP2023/000218

§ 371 Date: Jun. 13, 2025

(51) Int. Cl. G06F 3/14

(52) U.S. Cl. CPC G06F 3/1423

(57) ABSTRACT

Provided is a control device comprising an acquisition unit which acquires load information indicating a load relating to information processing, a determination unit which determines whether or not the load is a high load, an adjustment unit which adjusts, when the determination unit has determined that the load is a high load, an update timing for at least one screen component of a plurality of screen components to be displayed on a display screen, and a display unit which causes the at least one screen component to be displayed on a display screen on the basis of the update timing adjusted by the adjustment unit.

### RELATED APPLICATIONS

The present application is a National Phase of International Application No. PCT/JP2023/000218 filed Jan. 6, 2023.

### TECHNICAL FIELD

This disclosure relates generally to a controller that controls an industrial machine.

### BACKGROUND ART

A controller for controlling an industrial machine has a display screen on which multiple screen parts are displayed. Each of the screen parts displays information indicating a status of controlling the industrial machine.

In a case where each screen part is set to be updated in a short cycle, a processing load on the controller increases. Consequently, the controller may not be able to update the screen parts in a predefined update cycle. In order to solve such a problem, there are known systems that update the screen parts according to instructions from an operator (e.g. Patent Literature 1).

### PRIOR ART DOCUMENT

### Patent Literature

[Patent Literature 1] Japanese Patent Laid-Open Publication No. H11-238027

### BRIEF DESCRIPTION OF THE DRAWINGS

FIG. 1 is a block diagram showing an example of a hardware configuration of an industrial machine;

FIG. 2 is a block diagram showing an example of functions of a controller;

FIG. 3 illustrates screen parts;

FIG. 4 shows an example of an adjustment to update timing;

FIG. 5 is a flowchart showing an example of processing implemented by the controller;

FIG. 6 shows an example of the adjustment of the update timing;

FIG. 7 shows an example of the adjustment of the update timing;

FIG. 8 is a block diagram showing an example of the functions of the controller;

FIG. 9 shows an example of the adjustment of the update timing;

FIG. 10 is a block diagram showing an example of the functions of the controller;

FIG. 11 shows an example of the adjustment of the update timing; and

FIG. 12 shows an example of the adjustment of the update timing.

### DETAILED DESCRIPTION

The above-described systems require the operator to input an update cycle. The input of the update cycle becomes the burden on the operator. Furthermore, the operator may mistakenly input an inappropriate update cycle into the system. Thus, there is a need for a controller that can update the screen parts of the display screen appropriately while reducing the burden on the operator.

According to the disclosure, a controller includes: an acquisition unit that acquires load information that indicates a load related to information processing; a determination unit that determines whether the load is high or not; an adjustment unit that adjusts an update timing of at least one of multiple screen parts displayed on the display screen when the determination unit determines that the load is high; and a display unit that displays at least one of screen parts based on the update timing adjusted by the adjustment unit.

A controller according to an embodiment of the present disclosure will now be made by referring to the accompanying drawings. In the description below, the same reference numerals will be used for components with the same or similar functions. These components may not be described repeatedly.

In this application, the phrase “based on XX” means “at least based on XX” and includes other elements in addition to XX. Furthermore, the phrase “based on XX” is not limited only to a case where XX is used directly but also a case where computation and/or processing are carried out on XX. The word “XX” is an any element (e.g. arbitrary information).

A controller is configured to control industrial machinery. The industrial machinery operates on an industrial site. The industrial machinery includes, for instance, a machine tool, an injection molding machine, a laser machine, a three-dimensional printer, and a robot.

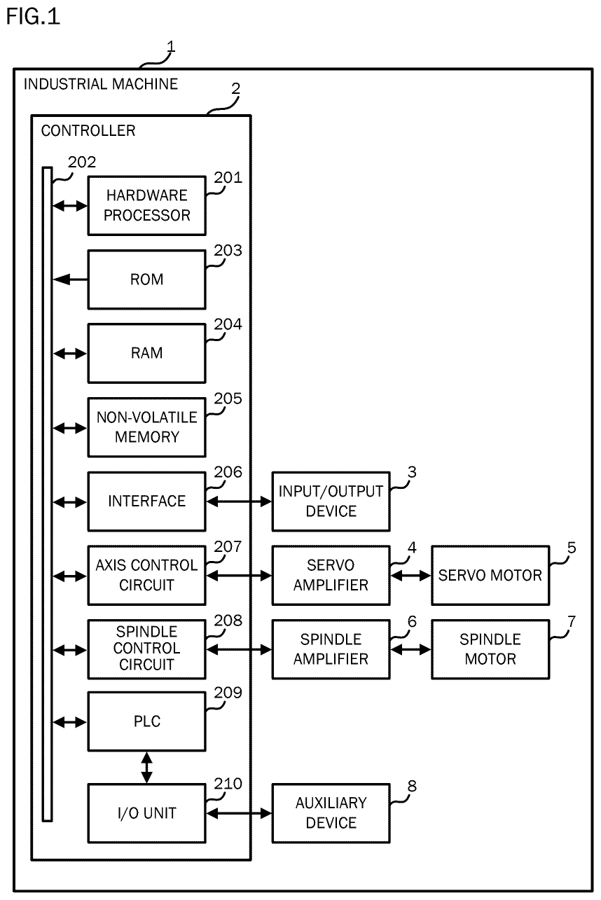

FIG. 1 is a block diagram showing an example of a hardware configuration of an industrial machine on which the controller is implemented. An industrial machine 1 includes a controller 2, an input/output device 3, a servo amplifier 4, a servo motor 5, a spindle amplifier 6, a spindle motor 7, and an auxiliary device 8.

The controller 2 is a numerical controller configured to control the industrial machine 1, by way of example. The controller 2 includes, for example, a hardware processor 201, a bus 202, a read only memory (ROM) 203, a random access memory (RAM) 204, and a non-volatile memory 205.

The hardware processor 201 is configured to control the entire controller 2 according to a system program. The hardware processor 201 reads a system program and others stored in the ROM 203 via the bus 202. The hardware processor 201 is, for example, a central processing unit (CPU) or electronic circuit.

The bus 202 is a communication channel configured to connect pieces of the hardware of the controller 2 to one another. The pieces of the hardware of the controller 2 exchange data with one another through the bus 202.

The ROM 203 is a storage unit configured to store the system program and others. The ROM 203 is a computer-readable storage medium.

The RAM 204 is a storage unit configured to temporarily store various data. The RAM 204 serves as a work area that enables the hardware processor 201 to process the various data.

The non-volatile memory 205 is a storage unit configured to retain data even when the controller 2 is turned off. The non-volatile memory 205 stores an operation program of the industrial machine 1, by way of example. The non-volatile memory 205 is a computer-readable storage medium. The non-volatile memory 205 consists of, for example, a battery-backed memory or a solid state drive (SSD).

The controller 2 further includes an interface 206, an axis control circuit 207, a spindle control circuit 208, a programmable logic controller (PLC) 209, and an I/O unit 210.

The interface 206 is configured to connect the bus 202 with the input/output device 3. The interface 206 transmits, for instance, the various data processed by the hardware processor 201 to the input/output device 3.

The input/output device 3 is configured to receive the various data via the interface 206 and display the data on a display. The input/output device 3 also receives various data inputs and transmits the various data via the interface 206 to the hardware processor 201, for instance.

The input/output device 3 is, for example, a touch panel. In the case where the input/output device 3 is the touch panel, the input/output device 3 is a capacitance touch panel, by way of example. The touch panel is not limited to the capacitance type and may be a different type touch panel. The input/output device 3 is installed to an operator's panel, not shown, into which the controller 2 is housed.

The axis control circuit 207 is configured to control the servo motor 5. The axis control circuit 207 receives control commands from the hardware processor 201 and sends various commands for driving the servo motor 5 to the servo amplifier 4. The axis control circuit 207 sends, for instance, a torque command for controlling torque of the servo motor 5 to the servo amplifier 4.

The servo amplifier 4 is configured to supply a current to the servo motor 5 in response to the commands from the axis control circuit 207.

The servo motor 5 is driven by the current supply from the servo amplifier 4. The servo motor 5 is provided to each control axis of the industrial machine 1. In a case where the industrial machine 1 is a machine tool having five axes, the servo motor 5 include, for example, an X-axis servo motor, a Y-axis servo motor, a Z-axis servo motor, an A-axis servo motor, and a C-axis servo motor. In this case, the axis control circuit 207 and the servo amplifier 4 are provided to each servo motor 5.

The servo motor 5 is coupled to a ball screw that drives a tool post, for instance. The servo motor 5 is driven to allow a structure of the industrial machine 1, such as the tool post, to move along a predetermined control axis.

The servo motor 5 incorporates an encoder, not shown, that is configured to detect the position of the control axis and a feedrate. Position feedback information and speed feedback information indicating the position of the control axis and the feedrate of the control axis, respectively, detected by the encoder are fed back to the axis control circuit 207. The feedback allows the axis control circuit 207 to conduct feedback control on each control axis.

The spindle control circuit 208 is configured to control the spindle motor 7. The spindle control circuit 208 receives control commands from the hardware processor 201 and sends commands for driving the spindle motor 7 to the spindle amplifier 6. For example, the spindle control circuit 208 sends a spindle speed command for controlling a rotation speed of the spindle motor 7 to the spindle amplifier 6.

The spindle amplifier 6 is configured to supply a current to the spindle motor 7 in response to the command from the spindle control circuit 208.

The spindle motor 7 is driven by the current supply from the spindle amplifier 6. The spindle motor 7 is coupled to a spindle to rotate it.

The PLC 209 is configured to execute a ladder program to control the auxiliary device 8. The PLC 209 sends commands to the auxiliary device 8 through the I/O unit 210.

The I/O unit 210 is an interface configured to connect the PLC 209 with the auxiliary device 8. The I/O unit 210 transmits the commands from the PLC 209 to the auxiliary device 8.

The auxiliary device 8 is installed on the industrial machine 1 and is configured to perform auxiliary operations in the industrial machine 1. The auxiliary device 8 operates based on the commands received from the I/O unit 210. The auxiliary device 8 may be disposed on the periphery of the industrial machine 1. The auxiliary device 8 is, for example, a turret, a coolant injection device, or a door open/close drive unit.

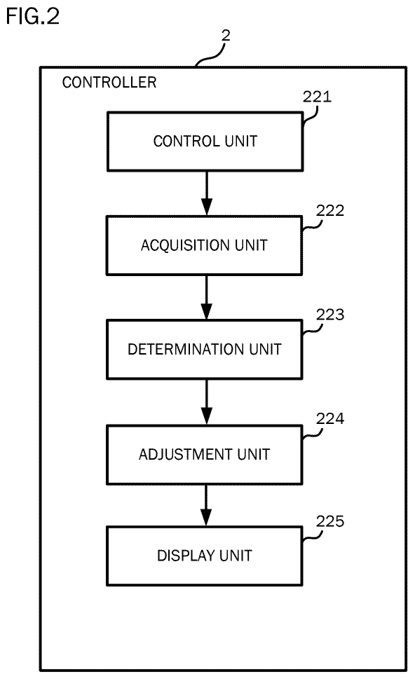

FIG. 2 is a block diagram showing an example of functions of the controller 2. The controller 2 includes a control unit 221, an acquisition unit 222, a determination unit 223, an adjustment unit 224, and a display unit 225.

For example, the control unit 221, the acquisition unit 222, the determination unit 223, the adjustment unit 224, and the display unit 225 are implemented by the hardware processor 201 performing arithmetic processing by using the system program stored in the ROM 203 and the various data stored in the non-volatile memory 205.

The control unit 221 is configured to control the industrial machine 1. For example, the control unit 221 controls the servo motor 5 of the industrial machine 1 based on an operation program. In a case where the industrial machine 1 is a machine tool, the control unit 221 controls the servo motor 5 and the spindle motor 7 based on a machining program. Thus, the industrial machine 1 conducts machining on a workpiece. The control unit 221 may conduct various information processing inside the controller 2 and communication processing with an external device.

The acquisition unit 222 is configured to acquire load information indicating a load of the information processing. The load information includes at least any one of information indicating a load on the hardware processor 201, information indicating an amount of access to a storage device, and information indicating an amount of communication with the external device. The load information may include information indicating a load of the control processing conducted by the control unit 221. The storage device is, for instance, the ROM 203, the RAM 204, and the non-volatile memory 205. The external device is, for instance, a server, not shown, that is connected to the controller 2.

The determination unit 223 is configured to determine whether the load indicated by the load information acquired by the acquisition unit 222 is high or not. The determination unit 223 compares a predefined threshold value with the load indicated by the load information to determine whether the load is high or not. The determination unit 223 may compare the predefined threshold value with a rate of increase in the load indicated by the load information to determine whether the load is high or not. The rate of increase is a rate of increase in the load per unit time.

The adjustment unit 224 is configured to adjust an update timing for at least one of multiple screen parts displayed on the display screen when the determination unit 223 determines that the load is high. The adjustment unit 224 adjusts the update timing by changing an update cycle.

The display screen is a monitor of the display device. The display device is the input/output device 3, by way of example. The screen parts are display areas for displaying the various control information.

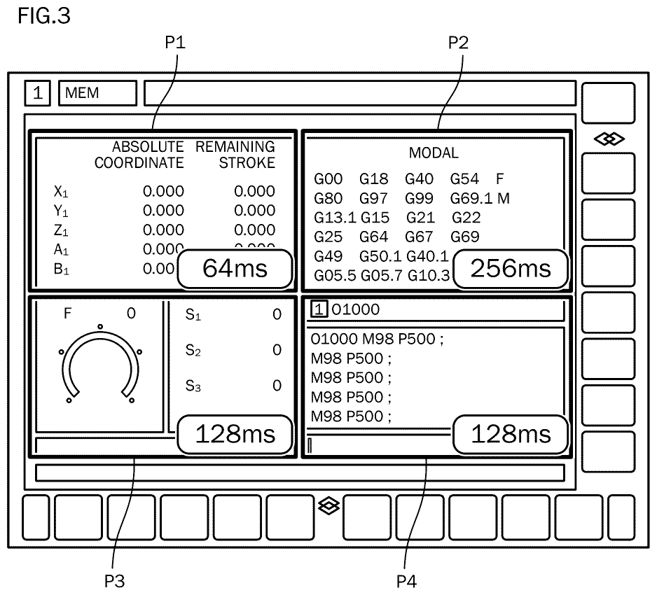

FIG. 3 illustrates the screen parts. The display screen displays multiple screen parts. The multiple screen parts display pieces of control information that are different from one another. For example, the multiple screen parts include a first screen part P1, a second screen part P2, a third screen part P3, and a fourth screen part P4.

The first screen part P1 displays coordinate information, for example. The coordinate information indicates coordinate values of each control axis during executing the operation program. For example, the coordinate information includes information indicating the coordinate values of the X-axis, the Y-axis, the Z-axis, the A-axis, and the B-axis.

The second screen part P2 displays modal information, for instance. The modal information indicates codes that are effective during executing the operation program. For example, the modal information includes G-codes, such as “G00”, “G01” and “G02”.

The third screen part P3 displays status information, for instance. The status information indicates a control status during executing the operation program. The status information includes information indicating a feedrate of each control axis and a rotation speed of the spindle.

The fourth screen part P4 displays program information, for example. The program information indicates the operation program during executing it. The operation program includes various commands that specify the operations of the industrial machine 1.

For example, the first screen part P1 has an update cycle of 64 [ms] in its initial setting. The coordinate information relates directly to a machining geometry of the workpiece, by way of example. Thus, the operator is required to check the coordinate information in real time. Accordingly, the update cycle of the first screen part P1 displaying the coordinate information is set to a relatively short cycle.

The second screen part P2 has, for instance, an update cycle of 256 [ms] in its initial setting. The modal information is not information that the operator should be checked in real time. Thus, the update cycle of the second screen part P2 displaying the modal information is set to a relatively long cycle.

The third screen part P3 has an update cycle of 128 [ms] in its initial setting, by way of example. The status information has an influence on the machining surface of the workpiece. It is therefore preferable that the operator checks the status information frequently. Accordingly, the update cycle of the third screen part P3 indicating the status information is set to a relatively medium cycle.

For example, the fourth screen part P4 has an update cycle of 128 [ms] in its initial setting. The program information has an influence directly on the workpiece machining. It is therefore preferable that the operator checks the program information frequency. Thus, the update cycle of the fourth screen part P4 displaying the program information is set to a relatively medium cycle.

FIG. 3 shows that each of the screen parts P1 to P4 displays the value indicating the update cycle in an approximate rectangular frame for illustrative purposes. Thus, these frames and the values are not displayed on a display screen in practice. However, in order to allow the operator to know the update cycles of the screen parts, the above-described frames and values may be displayed on the display screen.

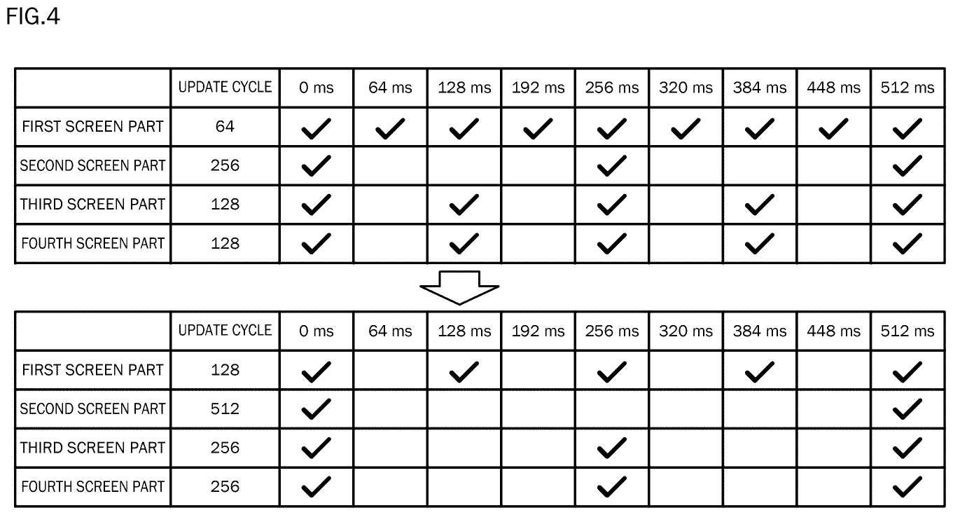

FIG. 4 is a diagram showing an example of an adjustment of the update timing. As described above, the update cycles for the first screen part P1 displaying the coordinate information, the second screen part P2 displaying the modal information, the third screen part P3 displaying the status information, and the fourth screen part P4 displaying the program information are 64 [ms], 256 [ms], 128 [ms], and 128 [ms], respectively, in the initial settings (see top table in FIG. 4). More specifically, the timings checked in the table in FIG. 4 are the update timings for the screen parts.

When the determination unit 223 determines that the load is high, the adjustment unit 224 changes, for instance, the update cycles for the first screen part P1, the second screen part P2, the third screen part P3, and the fourth screen part P4 into the longer cycles than the cycles in the respective initial settings. For example, in a case where the load on the hardware processor 201 is 95 % or more, the adjustment unit 224 adjusts the update cycles for the first screen part P1, the second screen part P2, the third screen part P3, and the fourth screen part P4 to be 128 [ms], 512 [ms], 256 [ms], and 256 [ms], respectively (see bottom table in FIG. 4).

The display unit 225 displays at least one screen part on the display screen based on the update timings adjusted by the adjustment unit 224. When the adjustment unit 224 changes the update cycles for the first screen part P1, the second screen part P2, the third screen part P3, and the fourth screen part P4 into 128 [ms], 512 [ms], 256 [ms], and 256 [ms], respectively, the display unit 225 updates the first screen part P1, the second screen part P2, the third screen part P3, and the fourth screen part P4 at the cycles of 128 [ms], 512 [ms], 256 [ms], and 256 [ms], respectively, so as to display the screen parts on the display screen. Thus, the controller 2 can reduce the load related to the information processing.

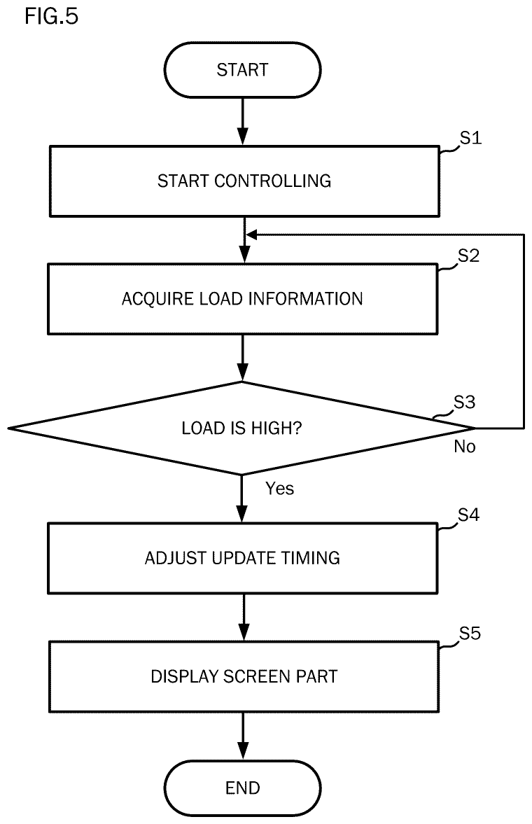

FIG. 5 is a flowchart showing an example of the processing conducted by the controller 2. First, when the execution of the operation program is started in the industrial machine 1, the control unit 221 starts controlling the industrial machine 1 (step S1). At this time, the display unit 225 updates and displays each screen part based on a predefined update cycle. The predefined update cycle is the update cycle in the initially setting, for instance.

Then, the acquisition unit 222 acquires the load information indicating the load related to the information processing (step S2).

Subsequently, the determination unit 223 determines whether the load is high or not (step S3).

When the determination unit 223 determines that the load is not high (No in step S3), the acquisition unit 222 continues acquiring the load information.

When the determination unit 223 determines that the load is high (Yest in step S3), the adjustment unit 224 adjusts the update timing of at least one of the multiple screen parts displayed on the display screen (step S4).

Then, the display unit 225 displays the screen parts on the display screen based on the update timing adjusted by the adjustment unit 224 (step S5). When the operation program is completed, the concerned processing is terminated.

The determination unit 223 may determine whether or not the load is reduced by making the display unit 225 to display the screen parts based on the update timing adjusted by the adjustment unit 224. For example, when the determination unit 223 determines that the load is not high, the adjustment unit 224 may conduct further update on each screen part at the predefined update cycle.

The adjustment unit 224 may adjust each update cycle within the maximum update cycle defined for each of the multiple screen parts.

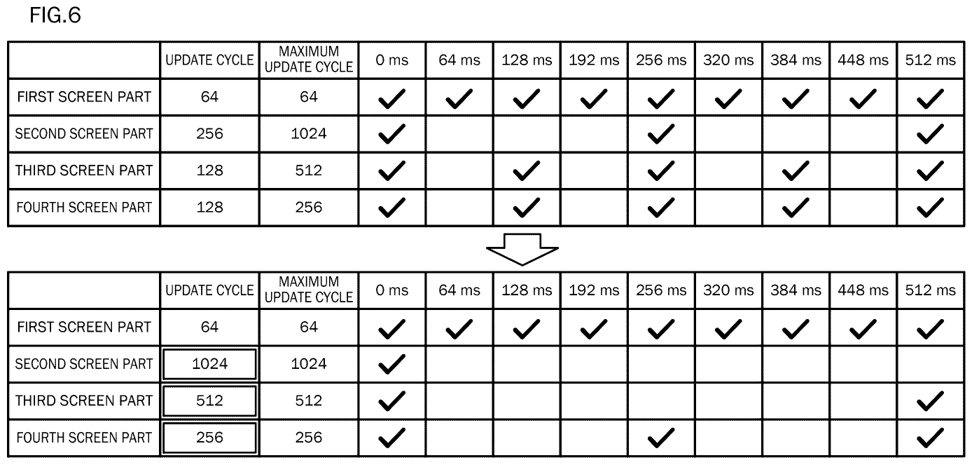

FIG. 6 shows an example of the adjustment of the update timing. As shown in FIG. 6, the maximum update cycle is set to each screen part. The update cycles for the first screen part P1 displaying the coordinate information, the second screen part P2 displaying the modal information, the third screen part P3 displaying the status information, and the fourth screen part P4 displaying the program information are 64 [ms], 256 [ms], 128 [ms], and 128 [ms], respectively, in the initial settings (see top table in FIG. 6).

Furthermore, the maximum update cycles of the first screen part P1, the second screen P2, the third screen part P3, and the fourth screen part P4 are 64 [ms], 1024 [ms], 512 [ms], and 256 [ms], respectively. The maximum update cycles are stored in a storage unit, not shown, for example.

When the determination unit 223 determines that the load is high, the adjustment unit 224 adjusts the update cycle of each screen part within the maximum update cycle.

The update cycle of the first screen part P1 is set to the maximum update cycle of 64 [ms] in the initial setting. Thus, the adjustment unit 224 does not change the update cycle of the first screen part P1 (see bottom table in FIG. 6).

The update cycle of the second screen part P2 is set to be shorter than the maximum update cycle of 1024 [ms] in the initial setting. Thus, the adjustment unit 224 changes the update cycle of the second screen part P2 from 256 [ms] in the initial setting to the maximum update cycle of 1024 [ms] (see bottom table in FIG. 6).

The update cycle of the third screen part P3 is set to be shorter than the maximum update cycle of 512 [ms] in the initial setting. Thus, the adjustment unit 224 changes the update cycle of the third screen part P3 from 128 [ms] in the initial setting to the maximum update cycle of 512 [ms] (see bottom table in FIG. 6).

The update cycle of the fourth screen part P4 is set to be shorter than the maximum update cycle of 256 [ms] in the initial setting. Thus, the adjustment unit 224 changes the update cycle of the fourth screen part P4 from 128 [ms] in the initial setting to the maximum update cycle of 256 [ms] (see bottom table in FIG. 6).

The adjustment unit 224 does not need to change the update cycles of the screen parts in their initial settings to their maximum update cycles, and the cycles may be within the respective maximum update cycles. For example, the adjustment unit 224 may change the update cycle of the second screen part P2 from 256 [ms] to 512 [ms].

The adjustment unit 224 may adjust the update cycle based on a priority level defined for each of the multiple screen parts.

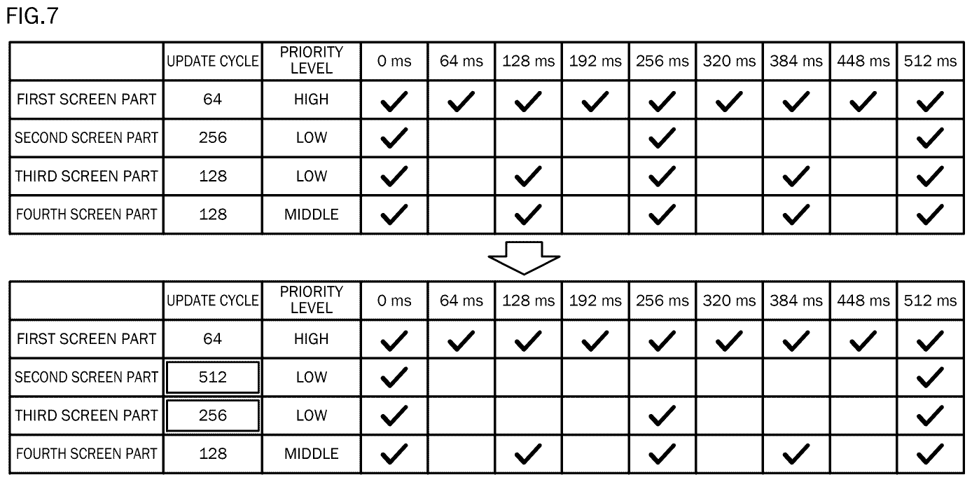

FIG. 7 shows an example of the adjustment of the update timing. As shown in FIG. 7, the priority level is defined for each screen part. The priority levels of the first screen part P1, the second screen part P2, the third screen part P3, and the fourth screen part P4 are “high”, “low”, “low”, and “medium”, respectively. These priority levels are stored in the storage unit, not shown, for instance.

When the determination unit 223 determines that the load is high, the adjustment unit 224 adjusts the update cycles based on the priority levels respectively defined for the multiple screen parts. That is to say, the adjustment unit 224 adjusts the update cycle of the screen part with lower priority level.

The priority level of the first screen part P1 is “high”. Thus, the adjustment unit 224 does not adjust the update cycle of the first screen part P1.

The priority levels of the second screen part P2 and the third screen part P3 are “low”. Thus, the adjustment unit 224 changes the update cycles of the second screen part P2 and the third screen part P3 from their initial settings of 256 [ms] and 128 [ms] to 512 [ms] and 256 [ms], respectively.

The priority level of the fourth screen part P4 is “medium”. In this case, the adjustment unit 224 does not adjust the update cycle of the fourth screen part P4. Alternatively, when the priority level of the fourth screen part P4 is “medium”, the adjustment unit 224 may adjust the update cycle of the fourth screen part P4. In a case where the priority level of any screen part is “medium”, the adjustment unit 224 may decide whether the update cycle of the concerned screen part is adjusted depending on the load.

The controller 2 may further include a frequency storage unit for storing the number of times the adjustment is conducted on the multiple screen parts.

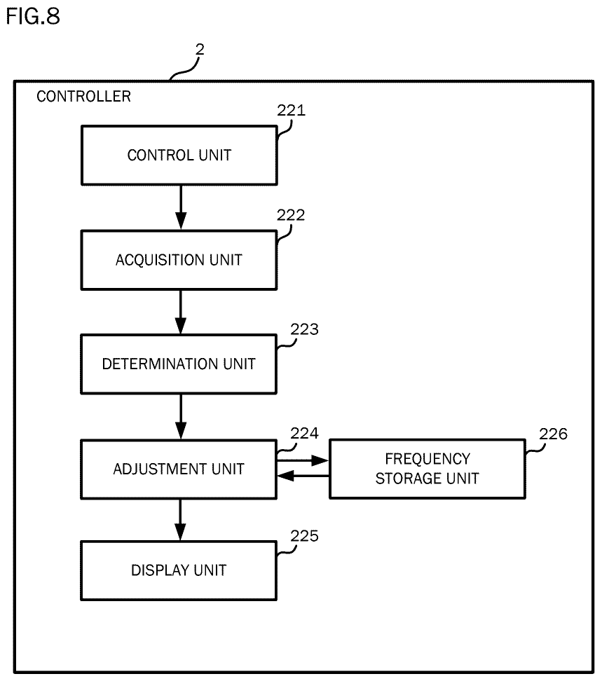

FIG. 8 is a block diagram showing an example of the functions of the controller 2 that has the frequency storage unit. The functions of the control unit 221, the acquisition unit 222, the determination unit 223, and the display unit 225 are the same as those of the control unit 221, the acquisition unit 222, the determination unit 223, and the display unit 225 of the controller 2 shown in FIG. 2. The frequency storage unit 226 is implemented by storing the number of times the adjustment is conducted on the multiple screen parts in the non-volatile memory 205, for example.

The frequency storage unit 226 is configured to store the number of times the adjustment is conducted on the update cycle for each of the multiple screen parts. In other words, the frequency storage unit 226 stores a history of adjustments conducted on the update cycle for each of the multiple screen parts.

The adjustment unit 224 adjusts the update cycles of the multiple screen parts based on the number of times of the adjustment stored in the frequency storage unit 226.

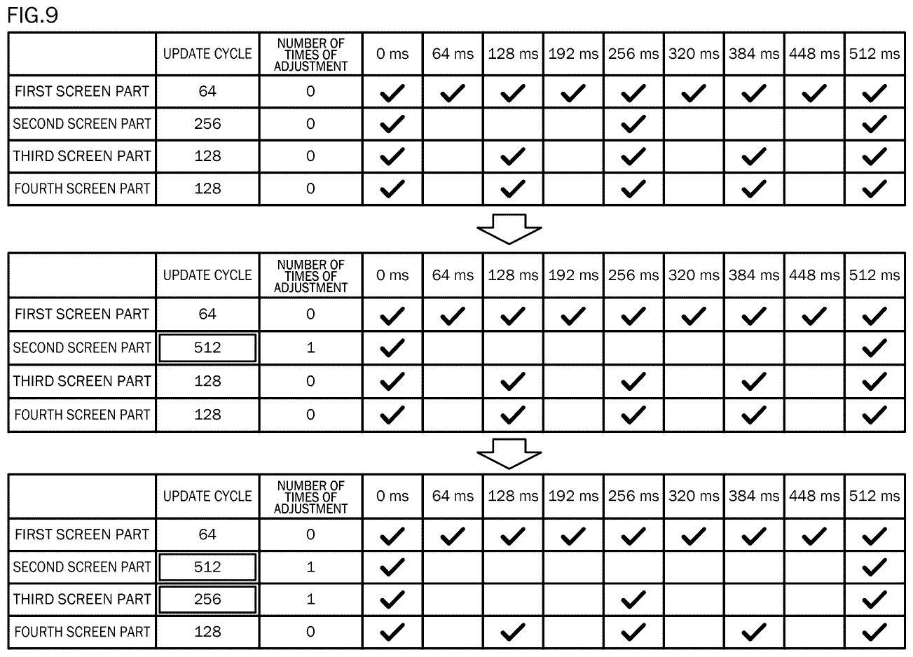

FIG. 9 shows an example of the adjustment on the update timing. As shown in FIG. 9, the frequency storage unit 226 stores the number of times of the adjustment by associating it with each of the multiple screen parts.

The numbers of times of the adjustment in the first screen part P1, the second screen part P2, the third screen part P3, and the fourth screen part P4 are “0” in their initial states (see top table in FIG. 9).

When the determination unit 223 determines that the load is high, the adjustment unit 224 adjusts the update timing for at least one of the multiple screen parts. For example, the adjustment unit 224 adjusts the update cycle of the screen part in which the load can be reduced most efficiently. The adjustment unit 224 changes the update cycle of the second screen part P2 from 256 [ms] to 512 [ms], by way of example. Then, the frequency storage unit 226 stores the number of times of the adjustment conducted on the second screen part P2 is “1” (see middle table in FIG. 9).

When the determination unit 223 determines that the load is high, the adjustment unit 224 adjusts the update timing for at least one of the multiple screen parts. In this case, the adjustment unit 224 refers to the number of times of the adjustment conducted on each screen part stored in the frequency storage unit 226, by way of example. The adjustment unit 224 selects the screen part whose update cycle is to be adjusted from among the screen parts that have the lowest number of times of the adjustment stored in the frequency storage unit 226.

The adjustment unit 224 adjusts the update cycle of the screen part in which the load can be reduced most efficiently, among the screen parts with the least number of times of the adjustment. For example, the adjustment unit 224 changes the update cycle of the third screen part P3 from 128 [ms] to 256 [ms]. Then, the frequency storage unit 226 stores the number of times of the adjustment conducted on the third screen part P3 is “1” (see bottom table in FIG. 9).

The controller 2 may further include a history storage unit that stores histories of the adjustment conducted on the update cycles by the adjustment unit 224.

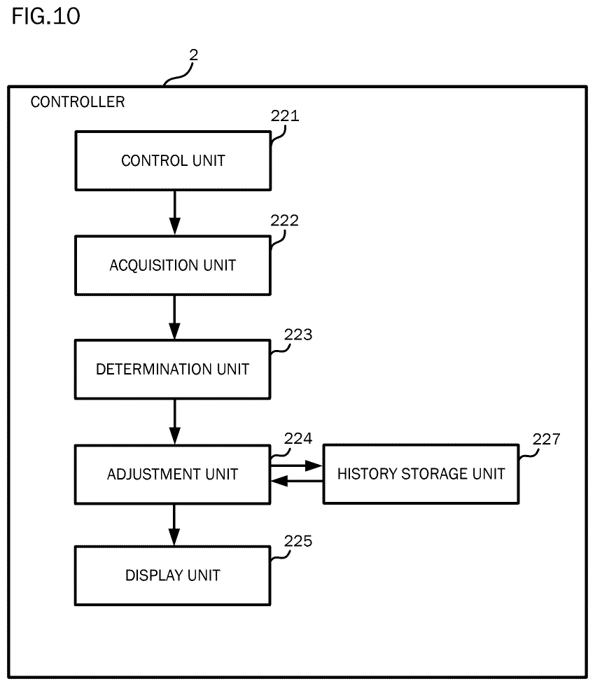

FIG. 10 is a block diagram showing an example of the functions of the controller 2 that has the history storage unit. The control unit 221, the acquisition unit 222, the determination unit 223, and the display unit 225 have the same functions as those of the control unit 221, the acquisition unit 222, the determination unit 223, and the display unit 225 of the controller 2 shown in FIG. 2. A history storage unit 227 is implemented by storing histories of changes in the update cycles of the multiple screen parts in the non-volatile memory 205, for instance.

The history storage unit 227 is configured to store histories of the update cycles adjusted by the adjustment unit 224. The history of the update cycle is information that indicates the update cycle of each screen part after the adjustment is conducted by the adjustment unit 224.

The adjustment unit 224 adjusts the update cycles of the multiple screen parts based on the histories of the update cycles stored in the history storage unit 227.

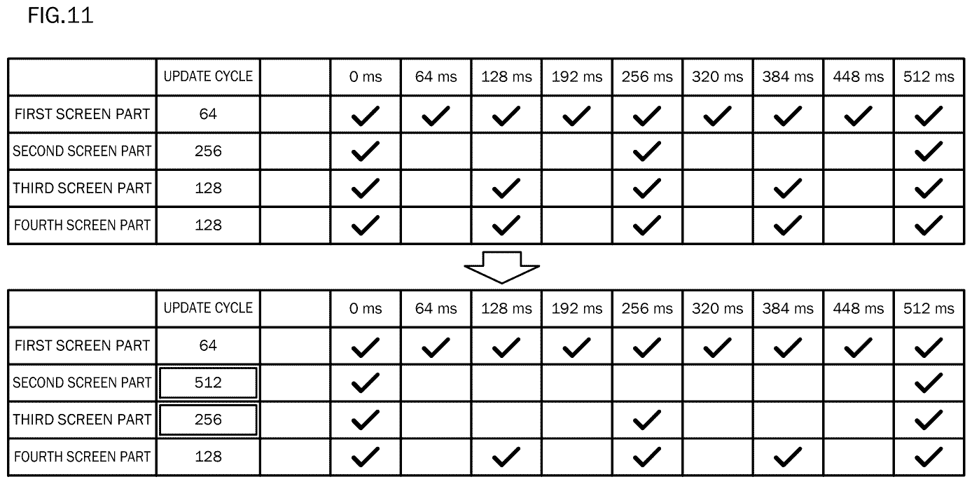

FIG. 11 shows an example of the adjustment of the update timing. The top table in FIG. 11 shows the update cycles of the screen parts in the initial state. That is to say, the update cycles of the first screen part P1, the second screen part P2, the third screen part P3, and the fourth screen part P4 are 64 [ms], 256 [ms], 128 [ms], and 128 [ms], respectively.

The bottom table in FIG. 11 shows the histories of the update cycles stored in the history storage unit 227. In other words, the update cycles of the first screen part P1, the second screen part P2, the third screen part P3, and the fourth screen part P4 are 64 [ms], 512 [ms], 256 [ms], and 128 [ms], respectively.

When the determination unit 223 determines that the load is high, the adjustment unit 224 adjusts the update cycles of the multiple screen parts based on the histories of the update cycles stored in the history storage unit 227. For example, the adjustment unit 224 changes the update cycle of the second screen part P2 from 256 [ms] to 512 [ms]. In addition to that, the adjustment unit 224 changes the update cycle of the third screen part P3 from 128 [ms] to 256 [ms].

The history storage unit 227 may store histories of the update cycles together with information indicating the load. For example, the history storage unit 227 may store the update cycle of each screen part adjusted by the adjustment unit 224 when the determination unit 223 determines that the load related to the information processing is 90 % of a reference value. Furthermore, the history storage unit 227 may store the update cycle of each screen part adjusted by the adjustment unit 224 when the determination unit 223 determines that the load related to the information processing is 95 % of the reference value. That is to say, the history storage unit 227 may store the update cycle of each screen part in association with information indicating multiple loads.

When the determination unit 223 determines that the load is high, the adjustment unit 224 may adjust the update timing by staggering the update timing in the multiple screen parts.

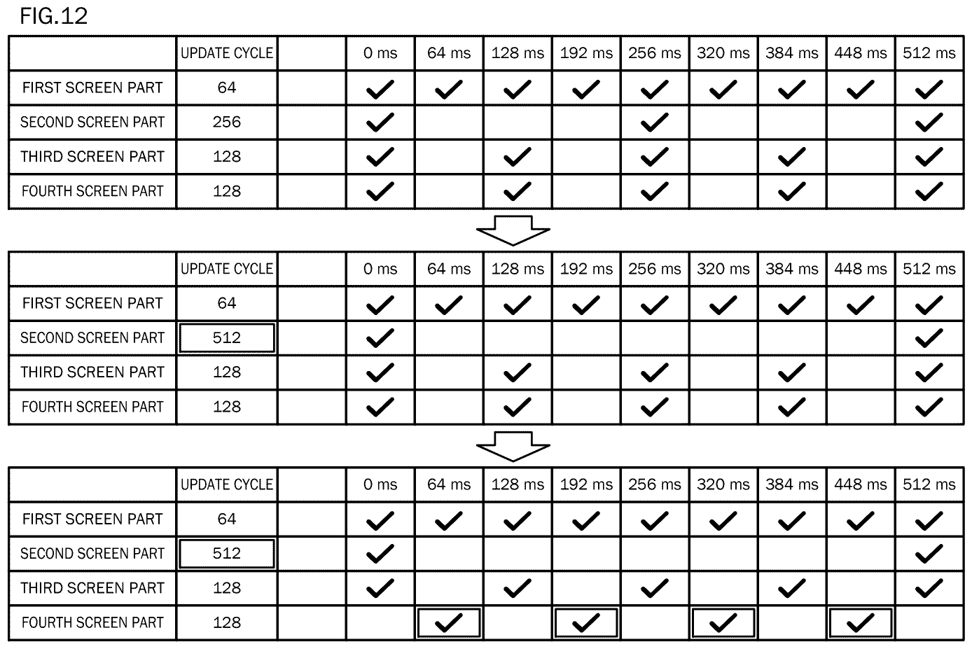

FIG. 12 shows an example of the adjustment of the update timing. The top table in FIG. 12 shows the update cycle of each screen part in the initial state. That is to say, the update cycles of the first screen part P1, the second screen part P2, the third screen part P3, and the fourth screen part P4 are 64 [ms], 256 [ms], 128 [ms], and 128 [ms], respectively.

The middle table in FIG. 12 shows that the update cycle of the second screen part P2 is changed from 256 [ms] to 512 [ms] when the determination unit 223 determines that the load is high. When the adjustment unit 224 changes the update cycle of the second screen part P2 from 256 [ms] to 512 [ms], the update is conducted on all of the first screen part P1, the second screen part P2, the third screen part P3, and the fourth screen part P4 at the timing 0 [ms] and the timing 512 [ms]. Thus, the adjustment unit 224 distributes the update timings of the multiple screen parts.

The bottom table in FIG. 12 shows that the adjustment unit 224 further distributes the update timings of the multiple screen parts when the determination unit 223 determines that the load is high.

The adjustment unit 224 changes the update timing of the fourth screen part P4 from the timing 0 [ms], the timing 128 [ms], the timing 256 [ms], the timing 384 [ms], and the timing 512 [ms] to the timing 64 [ms], the timing 192 [ms], the timing 320 [ms], and the timing 448 [ms]. In other words, there is no change in the update cycle of the fourth screen P4 before and after the adjustment. However, the update timing of the fourth screen part P4 is different before and after the adjustment. It can reduce the timing that all screen parts are updated simultaneously.

As described above, the controller 2 includes the acquisition unit 222 that acquires the load information indicating the load related to the information processing, the determination unit 223 that determines whether the load is high or not, the adjustment unit 224 that adjusts the update timing of at least one of the multiple screen parts displayed on the display screen when the determination unit 223 determines that the load is high, and the display unit 225 that displays at least one screen part on the display screen based on the update timings adjusted by the adjustment unit 224.

Thus, the controller 2 can reduce the burden on the operator to input the update timings of the screen parts. In addition to that, the controller 2 can prevent the update of the screen parts at an inappropriate timing due to an input error made by the operator. That is to say, the controller 2 can update the screen parts on the display screen appropriately.

The adjustment unit 224 also adjusts the update timing by varying the update cycles. Thus, the controller 2 can reduce the burden on the operator to input the update cycles of the screen parts. In addition to that, the controller 2 can prevent the update of the screen parts at the inappropriate timing due to the input error made by the operator. Consequently, the controller 2 can update the screen parts on the display screen appropriately.

The adjustment unit 224 also adjusts the update cycle within the maximum update cycle defined for each of the multiple screen parts. Thus, the controller 2 can prevent the update cycle of each screen part from being too long.

The adjustment unit 224 also adjusts the update cycle based on the priority level defined for each of the multiple screen parts. It enables prioritized update of the screen part that displays important control information. Consequently, the operator can check the important information in real time.

The controller 2 further includes the frequency storage unit 226 that stores the number of times the adjustment is conducted on the multiple screen parts, and the adjustment unit 224 adjusts the update cycles based on the number of times of the adjustment. It enables the controller 2 to keep a balance of the number of times of the adjustment between the screen parts. In other words, the controller 2 can prevent the adjustment of the update cycle only for a specific screen part.

The controller 2 further includes the history storage unit 227 that stores the histories of the update cycles adjusted by the adjustment unit 224, and based on the histories stored in the history storage unit 227, the adjustment unit 224 adjusts the update cycles. In this way, the adjustment unit 224 can adjust the update cycle of each screen part based on past performances. Thus, the adjustment unit 224 does not need to conduct a process of determining for which screen part the adjustment of the update cycle should be performed. It allows the controller 2 to reduce the load related to the information processing.

The adjustment unit 224 also adjusts the update timings by staggering the update timing of at least one of the multiple screen parts. That is to say, the adjustment unit 224 distributes the update timings of the screen parts without changing the update cycles of the screen parts. Thus, the controller 2 can reduce the load related to the information processing.

The load information includes at least any one of the information indicating the load on the hardware processor 201, the information indicating an amount of access to a storage device, and the information indicating an amount of communication with the external device. Thus, the controller 2 can reliably reduce the load related to the information processing.

The determination unit 223 also compares the predefined threshold value with the load or the rate of increase in the load to determine whether the load is high or not. It enables the control unit 221 to reliably determine whether the load related to the information process is high.

The present disclosure has been described in detail as above, but is not limited to the above-described individual embodiments. Thus, various additions, substitutions, modifications, partial deletions and so on may be made to these embodiments without departing from the gist of the disclosure or the spirit of the disclosure as derived from the contents described in the appended claims and their equivalents. Furthermore, these embodiments can be implemented by combining them.

In regard to the above-described embodiments, supplementary notes will be disclosed as below.

### Supplementary Note (1)

A controller that includes an acquisition unit that acquires load information indicating a load related to information processing, a determination unit that determines whether the load is high or not, an adjustment unit that adjusts update timing of at least one of multiple screen parts displayed on a display screen when the determination unit determines that the load is high, and a display unit that displays at least one of the screen part on the display screen based on the update timing adjusted by the adjustment unit.

### Supplementary Note (2)

The controller according to Supplementary Note (1), in which the adjustment unit adjusts the update timing by changing an update cycle.

### Supplementary Note (3)

The controller according to Supplementary Note (2), in which the adjustment unit adjusts the update cycle within a maximum update cycle defined for each of the multiple screen parts.

### Supplementary Note (4)

The controller according to Supplementary Note (2), in which the adjustment unit adjusts the update cycle based on a priority level defined for each of the multiple screen parts.

### Supplementary Note (5)

The controller according to Supplementary Note (2) further includes a frequency storage unit that stores the number of times the adjustment is conducted on the multiple screen parts, in which the adjustment unit adjusts the update cycle based on the number of times of the adjustment.

### Supplementary Note (6)

The controller according to Supplementary Note (2) further includes a history storage unit that stores histories of the update cycles adjusted by the adjustment unit, in which the adjustment unit adjusts the update cycle based on the histories stored in the history storage unit.

### Supplementary Note (7)

The controller according to Supplementary Note (1), in which the adjustment unit adjusts the update timings by staggering the update timing of at least one of the multiple screen parts.

### Supplementary Note (8)

The controller according to any of Supplementary Notes (1) to (7), in which the load information includes at least one of information indicating a load on a hardware processor, information indicating an amount of access to a storage device, and information indicating an amount of communication with an external device.

### Supplementary Note (9)

The controller according to any of Supplementary Notes (1) to (8), in which the determination unit compares a predefined threshold value with the load or a rate of increase in the load to determine whether the load is high or not.

1. A controller, comprising:
an acquisition unit that acquires load information indicating a load related to information processing;
a determination unit that determines whether the load is high or not;
an adjustment unit that adjusts an update timing of at least one of multiple screen parts displayed on a display screen when the determination unit determines that the load is high; and
a display unit that displays at least one of screen parts based on the update timing adjusted by the adjustment unit.

2. The controller according to claim 1, wherein the adjustment unit adjusts the update timing by changing an update cycle.

3. The controller according to claim 2, wherein the adjustment unit adjusts the update cycle within a maximum update cycle defined for each of the multiple screen parts.

4. The controller according to claim 2, wherein the adjustment unit adjusts the update cycle based on a priority level defined for each of the multiple screen parts.

5. The controller according to claim 2, further comprising a frequency storage unit that stores a number of times of adjustment conducted on the multiple screen parts, wherein
the adjustment unit adjusts the update cycle based on the number of times of the adjustment.

6. The controller according to claim 2, further comprising a history storage unit that stores a history of the update cycle adjusted by the adjustment unit, wherein
the adjustment unit adjusts the update cycle based on the history stored in the history storage unit.

7. The controller according to claim 1, wherein the adjustment unit adjusts the update timings by staggering the update timing of at least one of the multiple screen parts.

8. The controller according to claim 1, wherein the load information includes at least one of information indicating a load on a hardware processor, information indicating an amount of access to a storage device, and information indicating an amount of communication with an external device.

9. The controller according to claim 1, wherein the determination unit compares a predefined threshold value with the load or a rate of increase in the load to determine whether the load is high or not.
